(19) United States
(12) Patent Application Publication
(10) Pub. No.: US 2024/0160367 A1
(43) Pub. Date: May 16, 2024

(54) DYNAMICALLY ADJUSTING THE INITIAL POLLING TIMER IN MEMORY DEVICES

(71) Applicant: Micron Technology, Inc., Boise, ID (US)

(72) Inventors: Kai Wen Wu, Shanghai (CN); Yue Wei, Shanghai (CN); Peng Fei, Shanghai (CN); Donghua Zhou, Suzhou City (CN); Shao Chun Shi, Shanghai (CN)

(21) Appl. No.: 18/382,703

(22) Filed: Oct. 23, 2023

Related U.S. Application Data
(60) Provisional application No. 63/425,094, filed on Nov. 14, 2022.

(51) Int. Cl. G06F 3/06

(52) U.S. Cl. CPC G06F 3/0634; G06F 3/0604; G06F 3/0659; G06F 3/0679

(57) ABSTRACT

Systems and methods are disclosed including a memory device and a processing device operatively coupled to the memory device. The processing device can perform operations comprising receiving, from a host system, a memory access command; responsive to determining that the memory access command is a program command, incrementing a consecutive counter value; determining whether the consecutive counter value satisfies a threshold criterion; responsive to determining that the consecutive counter value satisfies a threshold criterion, and setting an initial polling timer to a value associated the consecutive counter value satisfying the threshold criterion.

### RELATED APPLICATION

This application claims the benefit of U.S. Provisional Application No. 63/425,094, filed Nov. 14, 2022, the entire content of which is hereby incorporated by reference.

### TECHNICAL FIELD

Embodiments of the disclosure relate generally to memory sub-systems, and more specifically, relate to dynamically adjusting the initial polling timer in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIGS. 2A-2B are flow diagrams of an example method for setting the initial polling timer based on the current workload, in accordance with some embodiments of the present disclosure.

FIG. 3 is a diagram illustrating the operations performed after issuing a memory access command, in accordance with some embodiments of the present disclosure.

FIG. 4 is a block diagram of an example computer system in which embodiments of the present disclosure can operate.

### DETAILED DESCRIPTION

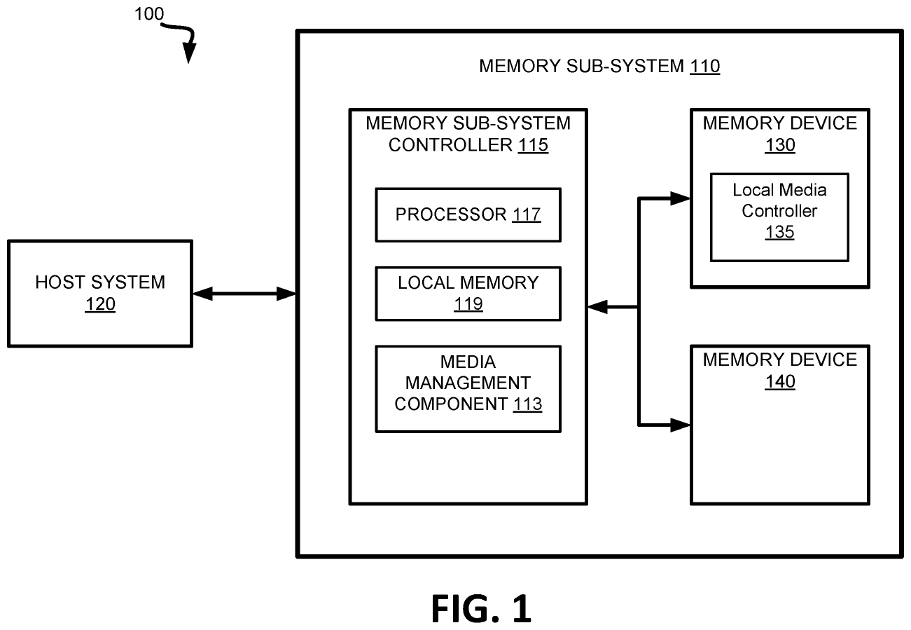

Aspects of the present disclosure are directed to dynamically adjusting the initial polling timer in memory devices. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include two or more planes. For some types of non-volatile memory devices (e.g., NAND devices), each plane includes a set of physical blocks. In some implementations, each block can include multiple sub-blocks. Each plane carries a matrix of memory cells formed on a silicon wafer and joined by conductors referred to as wordlines (WLs) and bitlines (BLs), such that a wordline joins multiple memory cells forming a row of the matrix of memory cells, while a bitline joins multiple memory cells forming a column of the matrix of memory cells.

Depending on the cell type, each memory cell can store one or more bits of binary information, and has various logic states that correlate to the number of bits being stored. The logic states can be represented by binary values, such as “0” and “1,” or combinations of such values. A memory cell can be programmed (written to) by applying a certain voltage to the memory cell, which results in an electric charge being held by the memory cell, thus allowing modulation of the voltage distributions produced by the memory cell. A set of memory cells referred to as a memory page can be programmed together in a single operation, e.g., by selecting consecutive bitlines.

Memory access operations can be performed by the memory sub-system. The memory access operations can be host-initiated operations or memory sub-system controller initialed. For example, the host system can initiate a memory access operation (e.g., write operation, read operation, erase operation, etc.) on a memory sub-system. The host system can send memory access commands (e.g., write command, read command) to the memory sub-system, such as to store data on a memory device at the memory sub-system and to read data from the memory device on the memory sub-system. The data to be read or written, as specified by a host request, is hereinafter referred to as “host data”. A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), etc. Memory access operations initiated by the memory sub-system controller can relate to maintenance operations, such as garbage collection, wear leveling, bad block management, block refresh operations, etc.

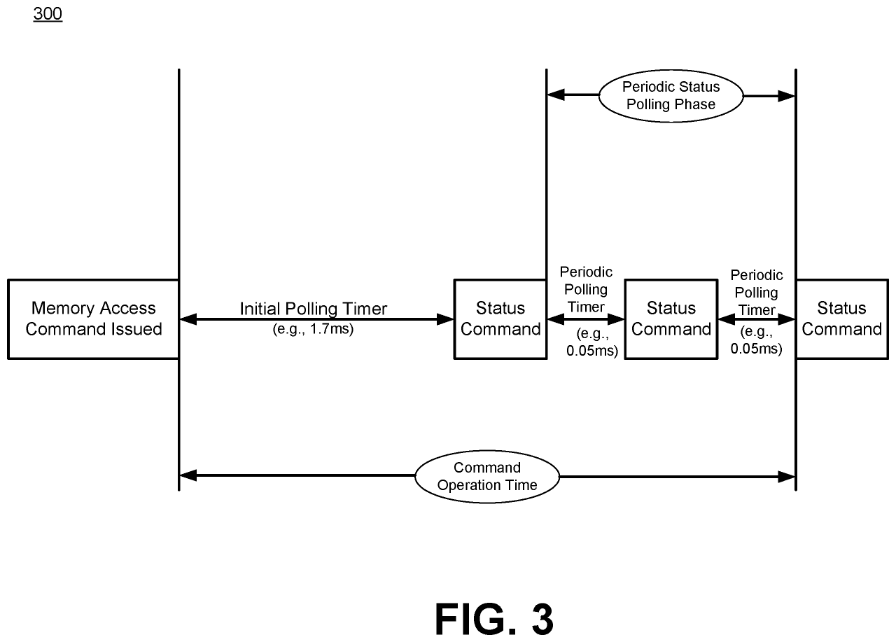

The memory sub-system controller can send a memory access command to the memory device via a data bus (e.g., open NAND flash interface (ONFI) bus) located between the memory sub-system controller and the memory device. As illustrated in the diagram of FIG. 3, upon sending the memory access command (e.g., a program command), the memory sub-system controller can then wait an initial predetermined period of time (e.g., await expiration of a timer) prior to sending, to the memory device, status command requesting the status of the memory device. This initial predetermined period of time can be configured by the firmware of the memory sub-system controller and is referred to as the “initial polling period” or “initial polling timer.” In an example, the initial polling period is set to the approximate time that the memory device requires to process the program command (e.g., 1.7 milliseconds (ms), 1.8 ms, etc.). The status command can inquire whether the memory device is ready or busy. A ready status can be indicative that the program command has been processed, while a busy status can be indicative of the memory device still processing the program command. If a busy status is received, the memory sub-system controller can wait an additional amount of time prior to sending, to the memory device, another status command. This additional period of time can also be configured by the firmware of the memory sub-system controller and is referred to as the referred to as the “periodic polling period” or “period polling timer.” In an example, the periodic polling period can be 0.05 ms. The memory sub-system controller can repeatedly send the status command until receipt of a ready status (referred to as the “periodic status polling phase”). Once a ready status is received, the memory sub-system controller can send the next memory access command (e.g., next program command). The total time between the issuance of the memory access command and the receiving the ready status is referred to as the “command operation time.”

In some instances, a memory sub-system can receive a request to perform a memory access operation, such as a program operation to program data supplied by the host, and then, before the program operation has been completed, receive a request to perform another memory access operation, such as a read operation on the same address. The memory sub-system can keep the data being programmed in the controller memory (e.g., dynamic random-access memory (DRAM)) while the memory device (e.g., not-and (NAND) type flash memory) of the memory sub-system is being programmed, and then flush the controller memory when the program operation is complete. As long as the programming time (i.e., the time for performing the program operation of the memory device) is relatively short, the controller memory of reasonable size can accommodate the data to be programmed. If, however, the memory device uses certain types of memory cells, such as triple level cells (TLCs) or quad-level cells (QLCs), the programming times can increase significantly. As such, the command processing latency associated with the subsequently received memory access operations is increased significantly. If a subsequent request to perform a read operation is received while the program operation is still ongoing, some memory sub-systems would wait until the program operation is complete before performing the read operation on the memory device. This can lead to significant latency in responding to requests from the host system.

In order to reduce latency in mixed workloads (e.g., a combination of write operations and read operations, such as a read operation followed immediately by a write operation), certain memory sub-systems utilize a program suspend protocol to allow subsequently received memory access commands (e.g., read command) to access the memory device on which a write operation is currently being performed. The program suspend protocol can temporarily pause the write operation to allow access to the memory array. In particular, when the memory sub-system receives a request to perform a memory access operation on the data stored in a certain page of the memory device while a write operation is in progress, the memory sub-system controller can issue a program suspend command, which causes the memory device to enter a suspended state.

In some systems, however, the program suspend protocol cannot be initiated during the periodic status polling phase, and rather can only be initiated during the initial polling phase. As such, if a memory device is still performing a program operation during the periodic status polling phase, and the memory sub-system controller receives a read command from a host, the memory device cannot perform the program suspend protocol so that the read command can be prioritized. As such, the program command continues to be processed, which increases the read latency of the memory sub-system. Alternatively, if the memory device is still performing a program operation during the initial polling phase, and the memory sub-system controller receives a read command from the host, the memory sub-system controller can instruct the memory device to enter program suspend protocol and process the read command. Processing the read command, however, will extend the command operation time of the initial program operation since the initial polling timer continues to expire. For example, a read command can consume approximately 0.05 ms to process. As such, the periodic status polling phase is extended. Since some memory devices can support multiple program suspend commands at a time (e.g., 30 program suspend command per page), the periodic status polling phase can cause the memory sub-system to experience significant latency in responding to host initiated read requests. For example, in a mixed workload of 30% write commands and 70% read commands, the command operation time for a program command can increase to approximately 2.8 ms, leading to a degraded quality of service. Furthermore, setting the initial polling timer to a higher value (e.g., 2.8 ms) to account for mixed workloads can impact a purely or mostly program workload by increasing the duration between each issued program command.

Aspects of the present disclosure address the above and other deficiencies by implementing a memory sub-system controller capable of dynamically adjusting the initial polling timer based on the workload experienced by the memory sub-system. In particular, the memory sub-system controller can receive a workload (e.g., a set of memory access commands) from the host system. For each memory access command, the memory sub-system controller can first determine whether the memory access command is a program command or a read command. Responsive to the memory access command being a program command, the processing logic can increase the value of consecutive count (CC) counter. Based on the current value of the CC counter, the processing logic can select an initial polling timer. For example, if the value of the CC counter satisfies a threshold criterion (e.g., the CC counter value is equal to or exceeds a threshold value), the memory sub-system controller can determine that the current workload is a program workload (or mostly a program workload). The memory sub-system controller can then set the initial polling timer to a predetermined value (e.g., 1.7 ms) reflective of the approximate command operation time necessary for processing program commands.

If the value of the CC counter fails to satisfy the threshold criterion (e.g., the CC counter value is less than the threshold value), the memory sub-system controller can determine that the current workload is a mixed workload. The memory sub-system controller can then set the initial polling timer to a predetermined value (e.g., 2.7 ms) reflective of the approximate command operation time necessary for processing program commands interrupted by a certain amount of program suspend operations.

The CC counter can be reset each time a read command, or a predetermined amount of read commands, is received. As such, the memory sub-system can determine whether a current workload is a program workload or a mixed workload, and dynamically change the initial polling timer based on the determined workload to appropriately improve read latency and/or program latency.

Advantages of the systems and methods implemented in accordance with some embodiments of the present disclosure include, but are not limited to, a reduction in complexity and improvement in performance of possessing workloads. This increase in performance includes reduced latency, particularly when the memory sub-system controller can adjust the initial polling period based on a workload type, thus enabling program suspend to function and improve read latency. Other advantages will be apparent to those skilled in the art, which will be discussed hereinafter. Although embodiments are described using wordlines of a NAND flash memory, aspects of the present disclosure can be applied to other types of memory sub-systems.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g. 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, and electrically erasable programmable read-only memory (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local controller 132) on the die and a controller (e.g., memory sub-system controller 115) for media management within the same memory device package. An example of a managed memory device is a managed NAND (MNAND) device.

The memory sub-system 110 includes a media management component 113 that can be used to handle interactions of memory sub-system controller 115 with the memory devices of memory sub-system 110, such as memory device 130. For example, media management component 113 can send memory access commands corresponding to requests received from host system 120 to memory device 130, such as write (program) commands, read commands, erase commands, or other commands. In addition, media management component 113 can receive data from memory device 130, such as data retrieved in response to a read command or a confirmation that a program (write) command was successfully performed. In some embodiments, media management component 113 can be part of a memory sub-system 110 having one or more memory devices 130. In some embodiments, the memory sub-system controller 115 includes at least a portion of media management component 113. For example, the memory sub-system controller 115 can include a processor 117 (processing device) configured to execute instructions stored in local memory 119 for performing the operations described herein. In some embodiments, media management component 113 is part of the host system 120, an application, or an operating system. In other embodiment, local media controller 135 includes at least a portion of media management component 113 and is configured to perform the functionality described herein.

In some embodiments, media management component 113 can further direct specific commands, including suspend and resume commands, to memory device 130 to manage collisions between different memory access operations. A collision can occur when a pending memory access operation is being performed on cells of a certain data block, sub-block, and wordline of memory device 130 when a request to perform a subsequent memory access operation on cells of the same data block, sub-block and wordline is received. In some embodiment, media management component 113 can suspend the pending memory access operation by issuing a designated suspend command to memory device 130 and then issuing a request to perform a subsequent memory access operation while the pending memory access operation is suspended.

In some embodiments, the media management component 113 can maintain a consecutive count (CC) counter 114. The CC counter 114 can maintain a value that is initially set to 0. In some embodiments, the CC counter 114 can reflect the number of consecutive program commands received by the memory device 130, 140 without receiving a threshold amount of memory access command type(s) (e.g., read commands, erase commands, etc.) that resets the CC counter 114. For each program command received, the value maintained by the CC counter 114 can be incremented, for example, by a value of 1. As will be explained in detail below, receiving a certain amount of non-program memory access command types (e.g., read commands) can reset the CC counter 114 to the initial value of 0. The CC counter 114 value can be used, by the media management component 113, to determine a current workload type (e.g., a mixed workload, a program workload, a read workload). A program workload refers to the memory device receiving only or primarily program commands (e.g., −99% program commands and −1% read commands). A read workload refers to the memory device receiving only or primarily read commands (e.g., −99% read commands and −1% program commands). A mixed workload refers to the memory device receiving a relative mix of program commands and read commands (e.g., −70% read commands and −30% program commands, −50% read commands and −50% program commands, −70% program commands and −30% read commands, etc.). As will be explained in detail below, in some embodiments, the media management component 113 can adjust the initial polling timer based on the current workload type experienced by the memory device 130, 140.

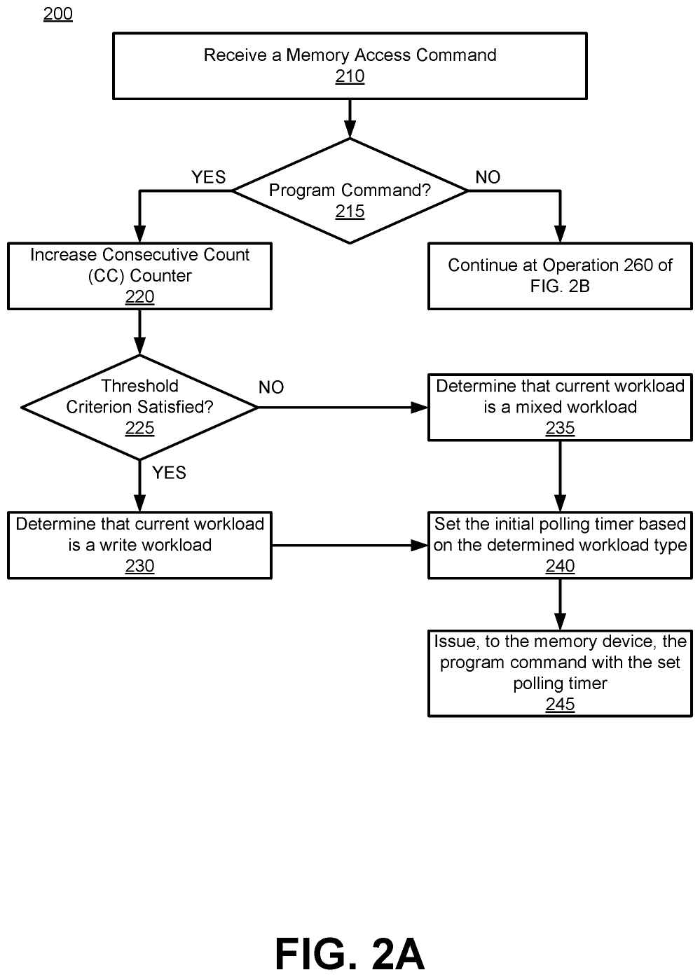

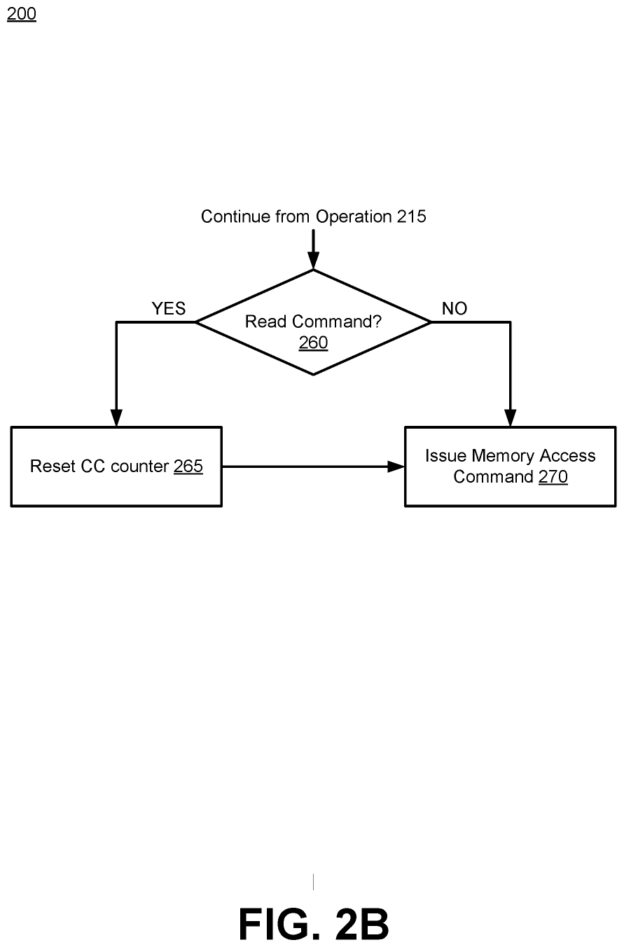

FIGS. 2A-2B are flow diagrams of an example method 200 for setting the initial polling timer based on the current workload, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the media management component 113 of FIG. 1 Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing logic receives a memory access command. The memory access command can be initiated by a host (e.g., host 120) or by a memory sub-system controller (e.g., memory sub-system controller 115). In some embodiments, the memory access command can include a read command, a program command, an erase command, etc.

At operation 215, the processing logic determines whether the memory access command is a program command. In some embodiments, to determine whether the memory access command is a program command, the processing logic inspects the opcode (operational code) of the memory access command, and compare the opcode to an opcode data structure (e.g., a metadata table). In some embodiments, the opcode can be located in the header of the memory access command. In some embodiments, the processing logic can determine whether the program command is a specific type of program command, such as, for example, a host-initiated program command.

Responsive to the processing logic determining that the memory access command is a program command, the processing logic proceeds to operation 220. Responsive to determining that the memory access command is not a program command (e.g., is a read command, an erase command, etc.), the processing logic proceeds to operation 260 of FIG. 2B.

At operation 220, the processing logic increases a consecutive count (CC) counter (e.g., CC counter 114). The CC counter can initially maintain a value set to 0 and, for each program command received, the value can be incremented (e.g., by a value of 1).

At operation 225, the processing logic determines whether the CC counter satisfies a threshold criterion. In some embodiments, satisfying the threshold criterion can include determining whether the CC counter value is equal to or exceeds a CC threshold value. The threshold value can be determined using a mathematical formula, based on operator (e.g., user) input, based on the output obtained from a machine-learning model, etc. In an embodiment, the threshold can be determined using the formula expressed below:

$$CC Threshold Value = \frac{( \frac{Queue Depth * Transfer Size}{Bandwidth} )}{( \frac{1}{CPU Frequency} ) * Cycles of a Supervisor Loop}$$

The queue depth can refer to the number of pending input/output (I/O) memory access commands that the memory sub-system 110 can process at any one time (e.g., 64, 128, 256, etc.). The transfer size can refer to the size of the sequential write workload (e.g., 64 kilobytes (kB), 128 kB, etc.). The bandwidth can refer to the throughput of the sequential write workload (e.g., 4,000 megabytes per second (MB/s), 5,000 MB/s, etc.). The CPU frequency can refer to the clock rate of the processor (e.g., 100 MHz, 500 MHz, 1,000 MHz, etc.). The cycles of a supervisor loop can refer to the amount of CPU cycles a single supervisor loop requires (e.g., 500 cycles, 1000 cycles, etc.). A supervisor loop can refer an event loop executed by the firmware of the memory sub-system to collect and process events, schedule operations, execute queued sub-tasks, etc. Accordingly, as an illustrative example, the CC threshold value can be set to 3,250, as seen below:

$$3 , 250 = \frac{( \frac{256 * 128 kB}{5 , 000 MB / s} )}{( \frac{1 μ s}{500} ) * 1 , 000}$$

Responsive to the CC counter satisfying the threshold criterion, the processing logic proceeds to operation 230 and determines that the current workload is a program workload, and proceeds to operation 240. A program workload indicates that the current set of memory access commands being received by the processing logic includes only or mostly program commands.

Responsive to the CC counter failing to satisfy the threshold criterion, the processing logic proceeds to operation 235 and determines that the current workload is a mixed workload, and proceeds to operation 240. A mixed workload indicates that the current set of memory access commands being received by the processing logic includes a mix write commands and read commands.

At operation 240, the processing logic sets the initial polling timer based on the determined workload type. When the determined workload type is a program workload, the processing logic can set the initial polling timer to a program workload value. The program workload value can be a predetermined value, such as, for example, the approximate duration (e.g., command operation time) the memory device requires to process a program command (e.g., 1.8 ms), a duration less than the approximate duration required for the memory device to process a program operation (e.g., 1.7 ms), etc. Since there are no or relatively few read operations during the program workload (thus no or few program suspend operations), the variation in the command operation time is relatively small, thus having a limited impact on read latency.

When the determined workload type is a mixed workload, the processing logic can set the initial polling timer to a mixed workload value. In a mixed workload, the command operation time for a program command can vary due to program suspend operations pausing the program command. For example, in a mixed workload of −70% read command and −30% write commands, the command operation time for a program command can be approximately 2.8 ms. The mixed workload value can, therefore, be a predetermined value reflecting the approximate duration (or a lesser value) the memory device generally takes to process a program command in a mixed workload (e.g., 2.8 ms, 2.7 ms, etc.). Accordingly, in a mixed workload, setting the initial polling timer to the mixed workload value can reduce read latency experienced by the unavailability of program suspend during the periodic status polling phase.

At operation 245, the processing logic issues, to the memory device, the program command with the set polling timer.

Referencing FIG. 2B, and responsive to determining, at operation 215 of FIG. 2A, that the memory access command is not a program command, the processing logic proceeds to operation 260. At operation 260, the processing logic determines whether the memory access command is a read command. In some embodiments, to determine whether the memory access command is a read command, the processing logic inspects the opcode (operational code) of the memory access command, and compare the opcode to an opcode data structure (e.g., a metadata table). In some embodiments, the processing logic can determine whether the read command is a specific type of program command, such as, for example, a host-initiated read command.

Responsive to the processing logic determining that the memory access command is a read command, the processing logic proceeds to operation 265. Responsive to determining that the memory access command is not a read command (e.g., is an erase command), the processing logic proceeds directly to operation 270 without performing any operations related to the CC counter (e.g., the processing logic doesn't increment or reset the CC counter value).

At operation 265, the processing logic resets the CC counter. For example, the processing logic can reset the read counter to a value of 0. In some embodiments, the processing logic can first increment a value of a read counter. The read counter can maintain a value that is initially set to 0 and can reflect the number of read commands received. For each read command received, the value maintained by the read counter can be incremented, for example, by a value of 1. Responsive to the read counter value satisfying a threshold criterion (e.g., equaling or exceeding a threshold value), the processing logic can reset the CC counter and the read counter. The read counter threshold criterion can be set based on user input (e.g., in response to testing results, experimentation results, etc.), based on an algorithm, based on the output of a machine-learning model, etc. Using the read counter can prevent the processing logic from resetting of the CC counter due to a relatively few read commands received during a mostly program workload.

At operation 270, the processing logic issues the memory access command to the memory device. For example, the processing logic can issue the read command or the erase command. In some embodiments, responsive to receiving the read command, the memory device can perform a program suspend operation to process the read command.

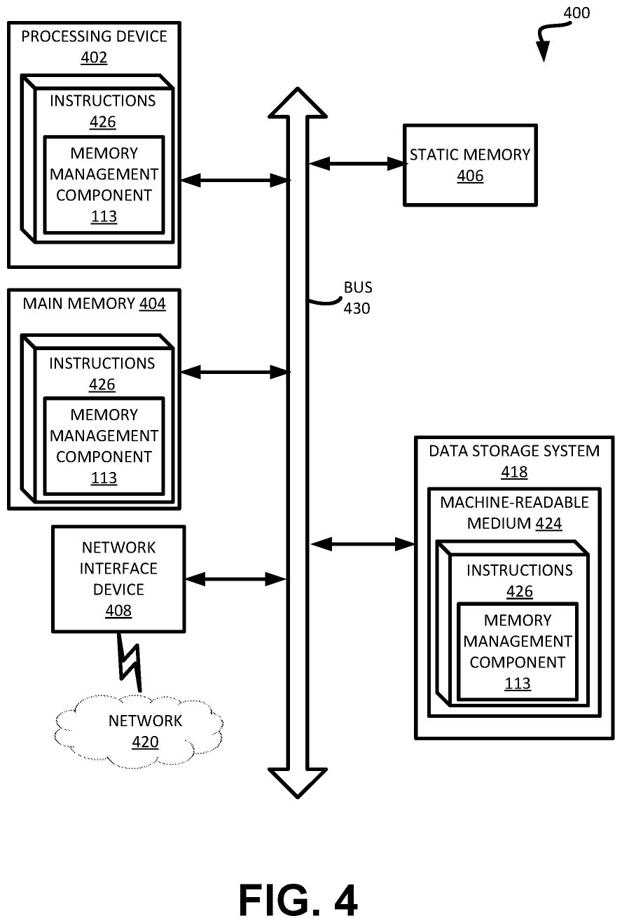

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1A) that includes or utilizes a memory sub-system (e.g., the memory sub-system 110 of FIG. 1A) or can be used to perform the operations of a controller (e.g., to execute an operating system to perform operations corresponding to media management component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430. Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to media management component 113 of FIG. 1. While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising:
receiving, from a host system, a memory access command;
responsive to determining that the memory access command is a program command, incrementing a consecutive counter value;
determining whether the consecutive counter value satisfies a threshold criterion; and
responsive to determining that the consecutive counter value satisfies a threshold criterion, setting an initial polling timer to a value associated with the consecutive counter value satisfying the threshold criterion.

2. The system of claim 1, wherein the operations further comprise:
responsive to determining that the consecutive counter value fails to satisfy the threshold criterion, setting the initial polling timer to a value associated with the consecutive counter value failing to satisfy the threshold criterion.

3. The system of claim 2, wherein the value associated with the consecutive counter value failing to satisfy the threshold criterion is greater than the value associated the consecutive counter value satisfying the threshold criterion.

4. The system of claim 1, wherein the operations further comprise:
responsive to determining that the memory access command is a read command, resetting the consecutive counter value.

5. The system of claim 1, wherein the operations further comprise:
responsive to determining that the memory access command is a read command, incrementing a read counter value.

6. The system of claim 5, wherein the operations further comprise:
responsive to determining that the read counter value satisfies a threshold criterion, resetting the consecutive counter value.

7. The system of claim 1, wherein the operations further comprise:
issuing, to the memory device, the program command with the initial polling timer set to the value associated the consecutive counter value satisfying the threshold criterion.

8. A method, comprising:
receiving, from a host system, a memory access command;
responsive to determining that the memory access command is a program command, incrementing a consecutive counter value;
determining whether the consecutive counter value satisfies a threshold criterion; and
responsive to determining that the consecutive counter value satisfies a threshold criterion, setting an initial polling timer to a value associated with the consecutive counter value satisfying the threshold criterion.

9. The method of claim 8, further comprising:
responsive to determining that the consecutive counter value fails to satisfy the threshold criterion, setting the initial polling timer to a value associated with the consecutive counter value failing to satisfy the threshold criterion.

10. The method of claim 9, wherein the value associated with the consecutive counter value failing to satisfy the threshold criterion is greater than the value associated the consecutive counter value satisfying the threshold criterion.

11. The method of claim 8, further comprising:
responsive to determining that the memory access command is a read command, resetting the consecutive counter value.

12. The method of claim 8, further comprising:
responsive to determining that the memory access command is a read command, incrementing a read counter value.

13. The method of claim 12, further comprising:
responsive to determining that the read counter value satisfies a threshold criterion, resetting the consecutive counter value.

14. The method of claim 8, further comprising:
issuing, to a memory device, the program command with the initial polling timer set to the value associated the consecutive counter value satisfying the threshold criterion.

15. A non-transitory computer-readable storage medium comprising instructions that, when executed by a processing device operatively coupled to a memory, performs operations comprising:
responsive to determining that a memory access command is a program command, incrementing a consecutive counter value;
determining whether the consecutive counter value satisfies a threshold criterion; and
responsive to determining that the consecutive counter value fails to satisfy the threshold criterion, setting the initial polling timer to a value associated with the consecutive counter value failing to satisfy the threshold criterion.

16. The non-transitory computer-readable storage medium of claim 15, wherein the operations further comprise:
responsive to determining that the consecutive counter value satisfies a threshold criterion, setting an initial polling timer to a value associated with the consecutive counter value satisfying the threshold criterion.

17. The non-transitory computer-readable storage medium of claim 16, wherein the value associated with the consecutive counter value failing to satisfy the threshold criterion is greater than the value associated the consecutive counter value satisfying the threshold criterion.

18. The non-transitory computer-readable storage medium of claim 15, wherein the operations further comprise:
responsive to determining that the memory access command is a read command, resetting the consecutive counter value.

19. The non-transitory computer-readable storage medium of claim 15, wherein the operations further comprise:
responsive to determining that the memory access command is a read command, incrementing a read counter value.

20. The non-transitory computer-readable storage medium of claim 19, wherein the operations further comprise:
responsive to determining that the read counter value satisfies a threshold criterion, resetting the consecutive counter value.
